(19) United States
(12) Patent Application Publication
(10) Pub. No.: US 2015/0165964 A1
(43) Pub. Date: Jun. 18, 2015

(54) VEHICLE WITH ILLUMINATED DISPLAY INSTRUMENT

(71) Applicant: GM GLOBAL TECHNOLOGY OPERATIONS LLC, Detroit, MI (US)

(72) Inventor: Erol Mori, Frankfurt (DE)

(21) Appl. No.: 14/567,871

(22) Filed: Dec. 11, 2014

(30) Foreign Application Priority Data
Dec. 13, 2013 (DE) 102013020782.7

(51) Int. Cl. B60Q 3/02; B60R 13/02

(52) U.S. Cl. CPC B60Q 3/0203; B60R 13/0243; B60Q 2500/10

(57) ABSTRACT

An inner lining element having an OLED embedded between a transparent outer layer and an opaque configuration layer is disclosed for the passenger compartment. The OLED includes layers of semiconducting organic material which are essentially transparent and colorless. Against the background of the opaque configuration layer they are practically invisible when inactive and not illuminated. The OLED embedded in the inner lining element can therefore be recognized only when contacted and supplied with a voltage.

### CROSS REFERENCE TO RELATED APPLICATION

This application claims priority to German Patent Application No. 102013020782.7 filed Dec. 13, 2013, which is incorporated herein by reference in its entirety.

### TECHNICAL FIELD

The present disclosure relates to a vehicle and in particular to mounting an illuminated display instrument in the vehicle, which informs the driver on operating states of the vehicle or points out certain events in the vehicle or its environment.

### BACKGROUND

Illuminated display instruments are often found on the dashboard of a vehicle, frequently in combination with switches which are illuminated by the illuminated display instruments in order to display the operating state of a device controlled by the switch or in order to make it easier to find the switch in the dark. The way in which illuminated display instruments and switches in a vehicle are fitted is different from one vehicle to another making it necessary to adapt the dashboard at considerable expense to individual requirements during assembly of the vehicle. In order to simplify such individual adaptations, weak areas may be pre-formed in the dashboard, indicating possible installation places on the dashboard and making it easier to form openings for mounting switches or illuminated displays. If such installation spaces remain unused they are often permanently visible in the finished vehicle. Also the fitting of various switches and displays into the adapted dashboard is connected with considerable expense.

### SUMMARY

In accordance with the present disclosure the installation of illuminated display instruments in a vehicle is made more effective. According to one arrangement of the present disclosure this requirement is met by an inner lining element for the passenger compartment, where at least one OLED is embedded between a transparent outer layer and an opaque configuration layer.

OLEDs include layers of semiconducting organic material which due to their minimal thickness are practically transparent and colorless. Against the background of the opaque configuration layer they are practically invisible when inactive and not illuminated. Whether and where an OLED is embedded in the inner lining element, can therefore be recognized only when this is contacted and supplied with a voltage. As a result, inner lining elements according to the present disclosure can be mounted in an identical manner in all vehicles of the same model independently of whether they are equipped with additional elements. Any OLED not associated with an additional element provided to display its operating state, may be left uncontacted. Its presence on the inner lining element is then not visible to the eye.

If the OLEDs provided in the inner lining element all display the same color the outer layer may be tinted accordingly. But if the OLEDs used can display different colors the outer layer should be colorless.

Since the OLEDs when switched off cannot be recognized, the configuration layer around the OLEDs may remain visible through the outer layer without impairing the overall aesthetic impression. There is then no need for conventional non-transparent frames around a light-permeable window of the inner lining element or for vignettes, which with conventional back-lit switches obscure a large part of the light generated by the light source lying behind the switch; if pictograms shall be made visible the OLEDs themselves can be shaped as pictograms.

A supply line for an OLED may, just as the OLED itself, be formed of a thin layer of transparent electric conducting material. A supply line of this kind may be run without being visible from the outside to a rim of the inner lining element, where it can be connected unobtrusively with an external feed line.

Contacting with an external feed line can easily be arranged by arranging metallic contact fields on the rim of the inner lining element.

In order to implement not only an illuminated display but also simultaneously a switch function, a contact sensor may be attached at the location of the OLED. Such a sensor, in particular a capacitive sensor, may, in the same way as the OLED, include thin conducting layers, wherein the layers of the sensor may be arranged, completely invisible from outside, behind the opaque configuration layer. As such it is possible to also arrange for the fitting of switches to be uniform for all vehicles of the same model, independently of any additional elements which might be provided, where the existence of an unused switch would be invisible from outside. This would simplify not only assembly of the vehicle but also the upgrading with additional elements after assembly because a switch required for controlling the additional element would then already exist.

The inner lining element according to the present disclosure does not necessarily have to be a dashboard or a part of a dashboard. Since the present disclosure allows illuminated display instruments to be attached in a very simply manner also at other locations in the passenger compartment, it is no longer necessary to assemble all display instruments on the dashboard, but other more convenient locations may be chosen.

Due to a preferred arrangement of the present disclosure a vehicle door may be equipped with an inner lining element of the kind described herein.

With a vehicle door of this kind at least one OLED may be conveniently arranged below a waistline, in particular the inner lining element may include an essentially vertical wall surface and a shoulder connecting this wall surface with a window lower edge, wherein the at least one OLED is arranged on the shoulder. Such an OLED may be utilized for offering to the driver supporting information which is relevant then when the driver looks through the side window or into a rear-view mirror arranged outside the side window.

In the same vein the inner lining element may, alternatively or additionally, fill a portion of the door between a waistline and a front edge of a door window, and at least one OLED may be arranged in the crotch or gusset therebetween.

Such a door-mounted OLED may be coupled in particular to a sensor for monitoring an environmental area on the outside of the door in order to indicate the presence of an object, in particular a vehicle in this environmental area.

It is also feasible to offer respective information with the aid of an OLED which is attached to an inner lining element covering an A-column of the vehicle.

### BRIEF DESCRIPTION OF THE DRAWINGS

The present disclosure will hereinafter be described in conjunction with the following drawing figures, wherein like numerals denote like elements.

FIG. 1 shows a schematic cross-section through an inner lining element according to the present disclosure;

FIG. 2 shows a detail of an inner lining element in a perspective view;

FIG. 3 shows an inner view of a vehicle, the passenger compartment of which is fitted with lining elements according to the present disclosure;

FIG. 4 shows an alternative inner view of a vehicle; and

FIG. 5 shows a schematic cross-section through an inner lining element according to the present disclosure, in which an OLED illuminated display is combined with a switch.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

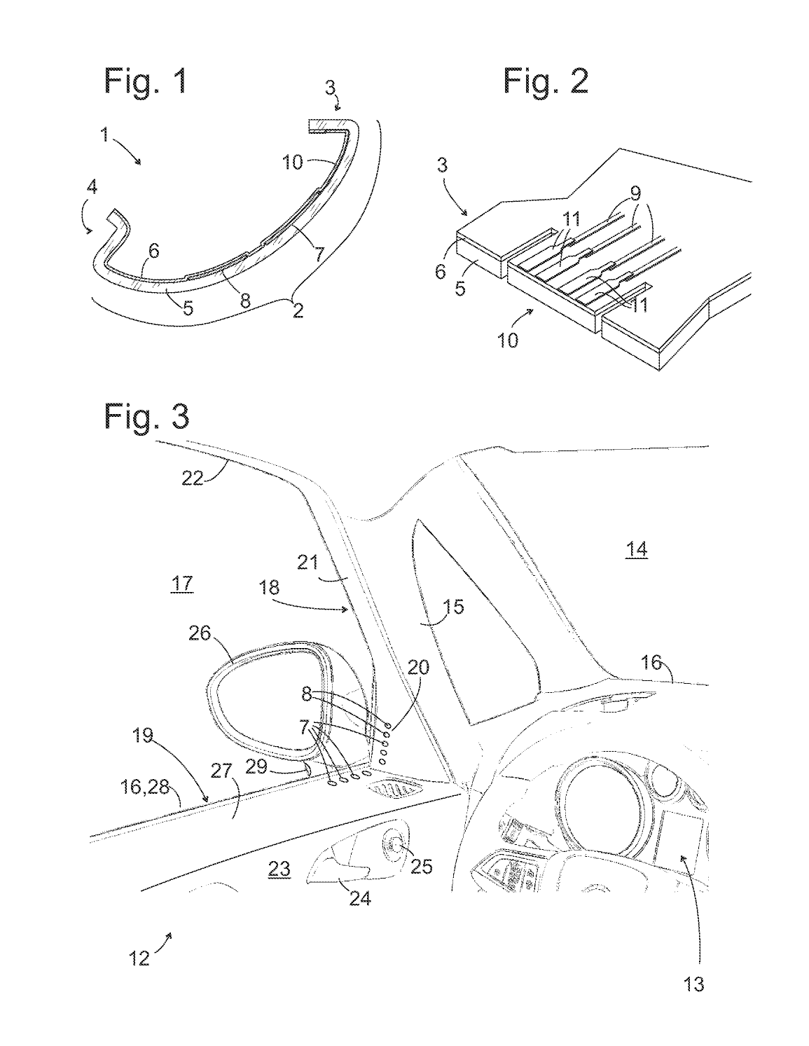

FIG. 1 shows an inner lining element 1 in a schematic cross-section. The figure shows an example of an inner lining element 1 for covering an A-column, with a core region 2 convexly curved towards the passenger compartment and rim regions 3, 4, bordering a front window not shown in the figure or fitted behind the frame of a door and therefore not visible to the occupants of the vehicle. An outer layer 5 made of crystal clear plastic forms the side of the inner lining element 1 facing the passenger compartment 1. The appearance of the inner lining element 1 is determined by a configuration layer 6, which is visible from the passenger compartment through the outer layer 5. The configuration layer 6 is a flexible plastic film, on which one or more OLEDs 7, 8 are formed, and which, for example with the aid of a self-adhesive coating, is applied to the inside of the stiff outer layer 5 facing the A-column. The thin layers of the OLEDs 7, 8 are practically colorless and therefore, as long as the OLEDs 7, 8 are not lit, are practically not recognizable through the outer layer 5. The color of the configuration layer 6 can, in principle, be freely selected. Nevertheless a dark tint is preferred because this maximizes the contrast between the lit OLEDs 7, 8 and the dark background against which they appear.

Supply lines 9 in the form of strips made of transparent, electrically conducting material extend from the OLEDs 7, 8 as far as into a rim region, here the rim region 3 of the inner lining element on the side of the window.

As shown in FIG. 2, a part of the rim region 3 is formed as a plug 10, which on the side of the configuration layer 6 carries exposed metallic contact fields 11 and which, by plugging it into a socket (not shown), can be connected with an external driver circuit for driving the OLEDs 7, 8. Each contact field 11 is connected via passageways in the configuration layer 6 with one of the conductor tracks 9, which are enclosed between the outer layer 5 and the configuration layer 6 so as to be protected like the OLEDs 7, 8 against atmospheric oxygen and moisture.

FIG. 3 shows an interior view of the passenger compartment of a vehicle in which inner lining elements are fitted with OLEDs embedded between an outer layer and a configuration layer, as described above, from the perspective of the driver. What can be seen is part of a door 12 of the vehicle, a dashboard 13 and the front windscreen 14, as well as an inner lining element 15, which covers an A-column laterally limiting the front windscreen 14. A waistline 16 of the vehicle body forms the lower edges extending upwards at the same height, of the front windscreen 14 as well as of a window 17 of the door 12. The door 12 includes, as is customary, a metallic support structure which from the driver's point of view is concealed by inner lining elements 18, 19. The elements 18, 19 are invisibly fastened to the support structure of the door 12.

The inner lining element 18 borders on a front edge of the window 17 and conceals a column of the support structure of the door 12, which extends parallel to the A-column. An approximately triangular base section 20 of the inner lining element 18 fills a portion of the door 12 between the front edge of the window 17 and the A-column and forms a gusset in the crotch therebetween. The base section 20 may be joined by an extension 21, which here extends up to an upper edge 22 of the window 17 and along the same towards the rear.

The inner lining element 19 lines the door 12 below the waistline 16. It includes a vertical wall surface 23 of which only a small part is shown, and to which may be attached a door unlocking lever 24 and an adjusting lever 25 for aligning a rear-view mirror 26 pivotally mounted on the outside of the door 12, as well as a shoulder 27 inclined slightly downwardly towards the interior of the vehicle, which shoulder connects the vertical wall surface 23 with the lower edge of the window 17.

The inner lining elements 18, 19 both are constructed as shown in FIG. 1 with a colorless transparent outer layer 5 and a colored or black, opaque configuration layer 6. OLEDs are embedded in the shoulder 27 along the lower edge 28 of the window 17. With the arrangement shown here the row of OLEDs extends past the border between the two inner lining elements 18, 19 into the base section 20. The OLEDs may be varicolored; in the case shown here the OLEDs 7 on the shoulder 27 and in a lower area of the base section 20 are red, whereas OLEDs 8 which form the upper end of the row in the base section 20 are green.

The OLEDs 7, 8 serve to indicate the recorded results of a dead angle monitoring device, for example a camera 29 which is housed in the shaft of the rear-view mirror 26. When the camera 29 detects a vehicle in the dead angle, it selects one of the OLEDs 7, 8 corresponding to the position of the vehicle, or perhaps several adjacent OLEDs 7, 8 in the case of a large vehicle such as a bus or a truck, for switching them on in order to draw the driver's attention, on the one hand, to the existence of the vehicle in the dead angle and on the other hand to indicate to him also the position of the vehicle by way of the position of the respectively lit OLEDs 7,8 in the row of OLEDs. Thus, when the vehicle overtakes, the OLEDs 7 in the inner lining element 19 are switched on one after the other from back to front, and thereafter the OLEDs 7, 8 in the inner lining element 18 are switched on from the bottom to the top. When one of the upper OLEDs 8 in the inner lining element 18 is lit the overtaking operation is largely completed, the overtaking vehicle is in front of the driver's vehicle, out of the dead angle, and is clearly visible to the driver. There is no longer any danger from this vehicle in case of a lane change and this is expressed by the green color of the OLEDs 8.

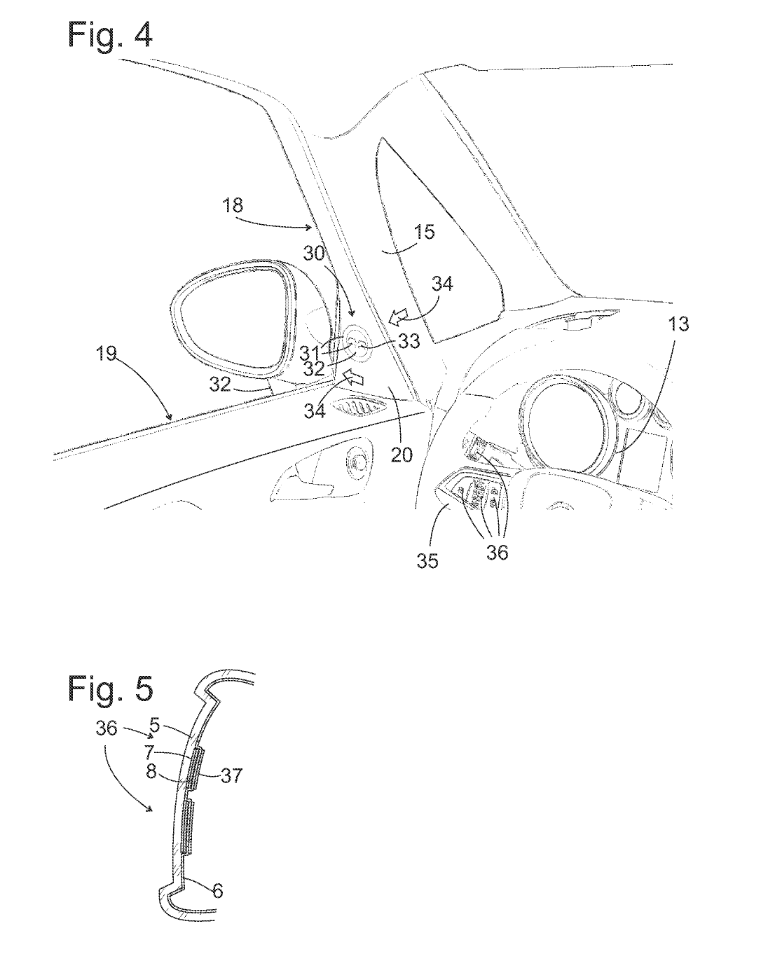

FIG. 4 shows an inner view of a passenger compartment according to a second arrangement of the present disclosure. Several varicolored OLEDs are combined at the base section 20 of the inner lining element 18, and these are switched on when a vehicle overtaking in the dead angle is detected with an image of a no-overtaking sign 30 being depicted. A single illuminated red OLED extends across red areas 31 and white areas 32 of the traffic sign 30; the white area 32 in addition includes a blue and a green OLED the light of which is superimposed on the red OLED thus appearing white to the eye. A black area 34 of the traffic sign 30 is free from OLEDs so that this area 34 appears dark when the OLEDs in the areas 31, 32 are switched on.

A turn-signal indicator may be formed by a further OLED 34 which is arranged adjacent to the traffic sign 30 in the inner lining element 18 or in the adjacent element 15 lining the A-column.

If there is sufficient space in the base section 20 of the inner lining element 18, this may be a location for combining the row of OLEDs 7, 8 from FIG. 3 and the traffic sign 30 from FIG. 4, in order to intuitively draw the driver's attention to the meaning of the OLEDs 7, 8 by switching on the OLEDs of the traffic sign 30 when an overtaking vehicle is detected.

Various operating state indicators 36, possibly combined with switches for altering the respectively displayed operating state of a closed element such as undipped/dipped/parking lights, cruise control etc. are distributed across the dashboard 13 and across a spoke of the steering wheel 35.

FIG. 5 shows a construction of an operating state indicator 36. The figure shows a section through a side visible to the driver, of a spoke of the steering wheel 36, whereby it is understood that the dashboard 13, in section, is identically constructed. Here too a stiff crystal clear outer layer 5 is backed with a flexible, pigmented configuration layer 6, and OLEDs 7, 8 are enclosed between the two. The OLEDs 7, 8 here are arranged in two layers, perfectly superimposed; they are shaped as pictograms respectively depicting the element to be controlled or the operating state to which they have been set. A proximity sensor 37, here in the form of capacitor layers, is attached to the back of the configuration layer 6, facing away from the driver. When the OLEDs 7, 8 are switched off the operating state indicator 36 cannot be distinguished from the surface of the steering wheel spoke surrounding it. One of the two OLEDs, here OLED 7, is therefore constantly in operation so that the driver can recognize where he must touch the steering wheel spoke in order to be detected by the proximity sensor 37 and to actuate the element controlled via this proximity sensor 37. When an actuation is detected the OLED 8 is additionally switched on, or OLED 8 is switched on and OLED 7 is switched off so that the driver can see by way of a change in color or brightness that his input has been detected and the element has been controlled accordingly.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. An inner lining assembly for the passenger compartment of a vehicle comprising:
an inner liner having a transparent outer layer and an opaque configuration layer; and
at least one OLED embedded between the transparent outer layer and the opaque configuration layer.

17. The inner liner assembly according to claim 16, wherein the outer layer is colorless.

18. The inner liner assembly according to claim 16, wherein the configuration layer is visible through the outer layer around the at least one OLED.

19. The inner liner assembly according to claim 16, wherein at least one of the outer layer and the configuration layer is flexible.

20. The inner liner assembly according to claim 16, wherein the OLED is shaped as a pictogram or part of a pictogram.

21. The inner liner assembly according to claim 16, further comprising a transparent supply line for the at least one OLED running between the outer layer and the configuration layer up to a rim of the inner liner assembly.

22. The inner liner assembly according to claim 21, wherein the rim comprises metallic contacts arranged thereon.

23. The inner liner assembly according to claim 16, further comprising a plurality of varicolored OLEDs embedded between the transparent outer layer and the opaque configuration layer.

24. The inner liner assembly according to claim 16, wherein a contact sensor is attached at the location of the at least one OLED.

25. A vehicle door comprising an inner liner assembly according to claim 16, wherein the inner liner assembly is positioned on at least a portion of interior surface of the door.

26. The vehicle door according to claim 25, wherein the at least one OLED is arranged below a waistline of the vehicle door.

27. The vehicle door according to claim 26, where the inner liner assembly further comprises an wall surface and a shoulder connecting the wall surface with a window lower edge, wherein the at least one OLED is arranged at the shoulder.

28. The vehicle door according to claim 25, where the inner liner assembly fills a portion of the door between a waistline and a front edge of a door window and the at least one OLED is arranged in a crotch region therebetween.

29. The vehicle door according to claim 25, where the at least one OLED is coupled to a sensor for monitoring an environmental area on a side of the door opposite the interior side for indicating the presence of an object in the environmental area.

30. A vehicle, wherein an inner liner assembly according to claim 16 forms an interior component of the vehicle selected from the group comprising a dashboard, a portion of a dashboard, a portion of a steering wheel or a cover of an A-column.
